(19) United States
(12) Patent Application Publication
(10) Pub. No.: US 2018/0299833 A1
(43) Pub. Date: Oct. 18, 2018

(54) ELECTRONIC DEVICE, MONITORING METHOD AND NON-TRANSIENT COMPUTER READABLE RECORDING MEDIUM

(71) Applicant: ASUSTEK COMPUTER INC., Taipei (TW)

(72) Inventors: Yun-Tse HSIAO, Taipei (TW); Ding-Chia KAO, Taipei (TW); Ling-Ying LEE, Taipei (TW); Po-Hung HUANG, Taipei (TW); Wei-Chung HUNG, Taipei (TW); Huai-Hao SYU, Taipei (TW); Yu-Siang LING, Taipei (TW); Shih-Hai LIN, Taipei (TW); Shih-Yu LIU, Taipei (TW); Wei-Chun HUANG, Taipei (TW)

(21) Appl. No.: 15/824,493

(22) Filed: Nov. 28, 2017

(30) Foreign Application Priority Data
Apr. 14, 2017 (TW) 106112559

(51) Int. Cl. G04B 47/06; G01P 13/00; G06N 5/04

(52) U.S. Cl. CPC G04B 47/06; G06N 5/046; G01P 13/00

(57) ABSTRACT

The present disclosure provides a monitoring method, an electronic device and a non-transient computer readable recording medium. The monitoring method includes the following steps: obtaining an instant sensing signal via an acceleration sensor; converting the instant sensing signal into at least one sensing parameter; and when the at least one sensing parameter satisfies one of the parameter determining rules, determining that the electronic device is in the current state defined correspondingly by the satisfied one of the parameter determining rules.

### CROSS-REFERENCE TO RELATED APPLICATION

This application claims the priority benefit of Taiwan application serial No. 106112559, filed on Apr. 14, 2017. The entirety of the above-mentioned patent application is hereby incorporated by reference herein and made a part of specification.

### BACKGROUND OF THE INVENTION

### Field of the Invention

The present disclosure relates to a monitoring method, an electronic device and a non-transient computer readable recording medium and, more specifically, to an electronic device, a method, and a non-transient computer readable recording medium that determines a physiological status of the electronic device accordingly.

### Description of the Related Art

In recent years, more and more wearable smart electronic devices are launched, such as smart watches and smart bands.

Wearable smart electronic devices can provide software operation functions via operation systems. Additionally, since wearable smart electronic devices are usually worn on arms and legs, a body or a head, they are adapted to be used to sense states of users. Therefore, various sensors are configured to sense physiological status of users.

### BRIEF SUMMARY OF THE INVENTION

According to an aspect of the disclosure, a monitoring method for an electronic device is provided. The electronic device comprises an acceleration sensor and a storage device stored with a plurality of parameter determining rules that defining a current state of the electronic device, the monitoring method comprising: obtaining an instant sensing signal via the acceleration sensor; converting the instant sensing signal into at least one sensing parameter; and determining the current state of the electronic device when the sensing parameter satisfies one of the parameter determining rules.

According to an aspect of the disclosure, an electronic device is provided. The electronic device comprises: an acceleration sensor configured to sense and obtain an instant sensing signal; a filter electronically connected with the acceleration sensor, wherein the filter is configured to receive the instant sensing signal and convert the instant sensing signal into at least one sensing parameter; and a comparison and determination module electronically connected with the filter, including: a storage device storing a plurality of parameter determining rules; and a processor electronically connected with the storage device, wherein the processor compares the at least one sensing parameter with the parameter determining rules to determine that the electronic device is in a current state defined by one of the parameter determining rules.

According to an aspect of the disclosure, a non-transient computer readable recording medium stored with at least one program instruction that applied to an electronic device, the electronic device including an acceleration sensor and a storage device stored with a plurality of parameter determining rules, after the program instruction is loaded in the electronic device, the following steps are executed: obtaining an instant sensing signal via the acceleration sensor; converting the instant sensing signal into at least one sensing parameter; and determining the current state of the electronic device when the sensing parameter satisfies one of the parameter determining rules.

### BRIEF DESCRIPTION OF THE DRAWINGS

FIG. 1 is a schematic diagram of an electronic device in an embodiment.

FIGS. 2A and 2B are flow charts of a monitoring method in an embodiment.

FIG. 3 is a schematic diagram showing an instant sensing signal obtained via the acceleration sensor in an embodiment.

FIG. 4 is a schematic diagram of time frequency distribution of an instant sensing signal after a short-time Fourier transform in an embodiment.

FIG. 5 is a schematic diagram showing a distribution of a time domain amplitude signal in a specific frequency band in an embodiment.

FIG. 6 is a waveform schematic diagram when an abnormal active state is sensed by an acceleration sensor in an embodiment.

FIG. 7 is a waveform diagram when a normal active state sensed by an acceleration sensor in an embodiment.

### DETAILED DESCRIPTION OF THE EMBODIMENTS

These and other features, aspects, and advantages of the disclosure will become better understood with regard to the following description, appended claims, and accompanying drawings. However, the embodiments are not limited herein. The components shown in figures are not used for limit the size or the proportion.

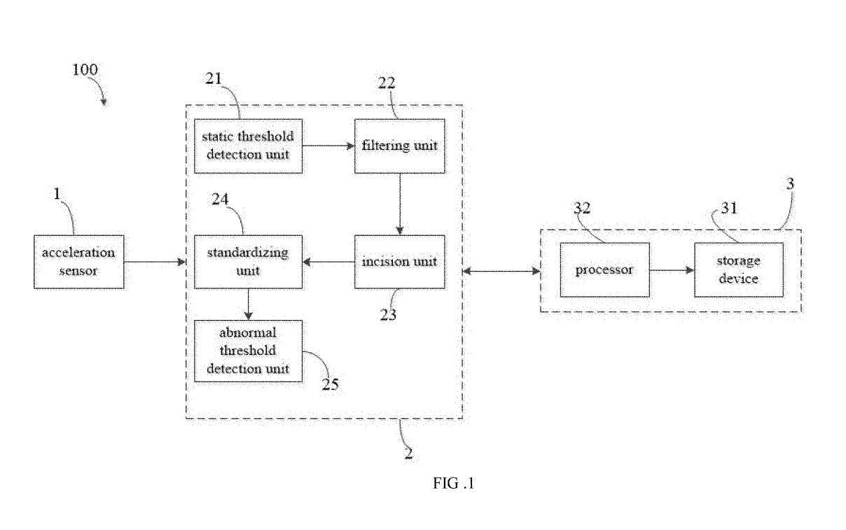

FIG. 1 is a schematic diagram of an electronic device in an embodiment. As shown in FIG. 1, an electronic device 100 includes an acceleration sensor 1, a filter 2 and a comparison and determination module 3. The acceleration sensor 1 is configured to sense and obtain an instant sensing signal. In the embodiment, the instant sensing signal is a time domain signal. The intensity value of the time domain signal is calculated in a unit of g (9.8 m/s²).

The filter 2 is electronically connected to the acceleration sensor 1. The filter 2 includes a static threshold detection unit 21, a filtering unit 22, an incision unit 23, a standardizing unit 24 and an abnormal threshold detection unit 25.

An upper limit value of the static signal intensity is stored in the static threshold detection unit 21. The upper limit value is used to distinguish an active state signal and a stationary state signal. When the instant sensing signal is smaller than the upper limit value of the static signal intensity, the instant sensing signal is determined as the stationary state signal. When the instant sensing signal is larger than the upper limit value of the static signal intensity, the instant sensing signal is determined as the active state signal.

The stationary state signal refers to the instant sensing signal obtained via the acceleration sensor 1 when the electronic device 100 is at a stationary state. The active state signal refers to the instant sensing signal obtained via the acceleration sensor 1 when the electronic device 100 is in an active state. In the embodiment, the upper limit value of the static signal intensity is set as follows. A large quantity of the active state signals and the stationary state signals are obtained via the acceleration sensor 1. A signal standard deviation is processed on the active state signals and the stationary state signals. Then, after statistical analysis, the signal standard deviation of the stationary state signals is smaller than 0.43 g (m/s²), and the signal standard deviation of the active state signals is larger than 0.43 g (m/s²). As a result, the value 0.43 g (m/s²) is regarded as the upper limit value of the static signal intensity.

As above, when the intensity value of the instant sensing signal is smaller than the upper limit value of the static signal intensity, a stationary state parameter determining rule of multiple parameter determining rules is adapted to the instant sensing signal. When the intensity value of the instant sensing signal is larger than or equal to the upper limit value of the static signal intensity and smaller than or equal to an upper limit value of the dynamic signal intensity, a signal intensity periodical change determining rile is adapted to the instant sensing signal. When the intensity value of the instant sensing signal is larger than the upper limit value of the dynamic signal intensity, a signal intensity abrupt change determining rule is adapted to the instant sensing signal.

The filtering unit 22 filters the instant sensing signal to output a frequency band sensing signal according to the frequency band corresponding to at least one of parameter determining rules. The stationary state parameter determining rule corresponds to the frequency band from 0.01 Hz to 2 Hz. The signal intensity periodical change determining rule and the signal intensity abrupt change determining rule correspond to the frequency bands larger than 2 Hz or smaller than 0.01 Hz. In other words, the frequency bands corresponding to the signal intensity periodical change determining rule and the signal intensity abrupt change determining rule are exclusive of the frequency bands from 0.01 Hz to 2 Hz.

The incision unit 23 is connected with the filtering unit 22. The incision unit 23 incises the frequency band sensing signal into at least one unit sensing signal. The incision unit 23 incises the frequency band sensing signal in a time interval to generate at least one unit sensing signal. For example, the stationary parameter determining vile is used to determine the signal with lower time domain value, and the signal intensity periodical change determining rule is used to determine whether signals are periodical. As a result, the time intervals for the stationary parameter determining rule and the signal intensity periodical change determining rule to perform an incision are longer. For example, the frequency band sensing signal is incised via a time interval of 10 seconds. The signal intensity abrupt change determining rule is used to determine an abrupt state. Thus, a time interval for the signal intensity abrupt change determining rule to have an incision is shorter, such as between 1 and 5 seconds.

The standardizing unit 24 is connected with the incision unit 23. The standardizing unit 24 is used to generate at least one sensing parameter by standardizing the unit sensing signal. In an embodiment, the standardizing unit 24 processes the unit sensing signal by using an algorithm such as Fourier Transform.

The abnormal threshold detection unit 25 is electronically connected to the standardizing unit 24. An upper limit value of the dynamic signal intensity is stored in the abnormal threshold detection unit 25. The upper limit value of the dynamic signal intensity is used to distinguish a normal active state and an abnormal active state. When the intensity value of the instant sensing signal is larger than the upper limit value of the dynamic signal intensity, the current state of the electronic device 100 is the abnormal active state. When the intensity value of the instant sensing signal is not larger than the upper limit value of the dynamic signal intensity, the current state of the electronic device 100 is the normal active state.

In the present embodiment, the upper limit value of the dynamic signal intensity is set as follows. A large quantity of the normal active state signals and the abnormal active state signals are obtained via the acceleration sensor 1. The normal active state signals and the abnormal active state signals are processed via the filtering unit 22, the incision unit 23 and the standardizing unit 24 to generate sensing parameters. Then, after statistical analysis, the sensing parameters (the summation of the tri-axial signal differences) for the abnormal active state signals are larger than 15 g (m/s²). Thus, the instant sensing is regarded as the abnormal active signal when the sensing parameter of the instant sensing signal is larger than 15 g. The instant sensing is regarded as the normal active signal when the sensing parameter of the instant sensing signal is not larger than 15 g.

The comparison and determination module 3 is electronically connected to the filter 2. The comparison and determination module 3 includes a storage device 31 and a processor 32. Parameter determining rules are stored in the storage device 31. The processor 32 is electronically connected with the storage device 31. The processor 32 is configured to compare at least one sensing parameter with the parameter determining rules to determine the current state of the electronic device.

In an embodiment, the storage device 31 is a memory, a hard disc, a portable memory card. In an embodiment, the processor 32 is a microcontroller, a microprocessor, a digital signal processor, an application specific integrated circuit (ASIC) or a logic circuit.

In the embodiment, the multiple parameter determining rules stored in the storage device 31 includes the stationary parameter determining rule, the signal intensity abrupt change determining rule and the signal intensity periodical change determining rule.

In the stationary parameter determining rule, a preset static time domain value is preset, and the current state of the electronic device is determined as a static wearing state when the stationary state determining parameter is larger than the preset static time domain value. When the stationary state determining parameter is not larger than the preset static time domain value, the current state of the electronic device is determined as a static placement state. In the embodiment, the preset static time domain value is 0.02 g.

In the signal intensity abrupt change determining rule, an abnormal parameter is preset, and the current state of the electronic device is determined as the abnormal active state when the abnormal state parameter is larger than the preset abnormal parameter. In an embodiment, the abnormal state parameter is the characteristic value of the tri-axial acceleration change obtained from the instant sensing signal, and the preset abnormal parameter is the statistical characteristic value of the tri-axial acceleration change at different abnormal states. For example, the abnormal state includes the states such as falling down, being hit or falling off.

In the signal intensity periodical change determining rule, a double layer probability model is preset. The first layer of the double layer probability model is a multiple-classes probability model, and the second layer of the double layer probability model is a binary classifier. For example, the normal active state parameter is the characteristic value of the tri-axial acceleration change obtained from the instant sensing signal. According to the signal intensity periodical change determining rule, the characteristic value of the tri-axial acceleration change is filtrated by the double layer probability model to obtain predefined normal active states. Then, the current state of the electronic device 100 is determined as one of the predefined normal active states according to whether the characteristic value of frequency domain in the instant sensing signal has periodicity. For example, the normal active states includes at least one of a walking state, a running state, a vehicle taking state and a clerical activity state.

In detail, the signal intensity periodical change determining rule is to incise all types of normal active states via the hyperplane (which is generated by the pre-trained classifiers) in the characteristic space. Then, there is an incision hyperplane between each two types of normal active states. Thus, after the instant sensing signals are converted into the characteristic vectors, the type of normal active state is determined according to the relative position relationship between the characteristic vectors and the hyperplanes in the characteristic space.

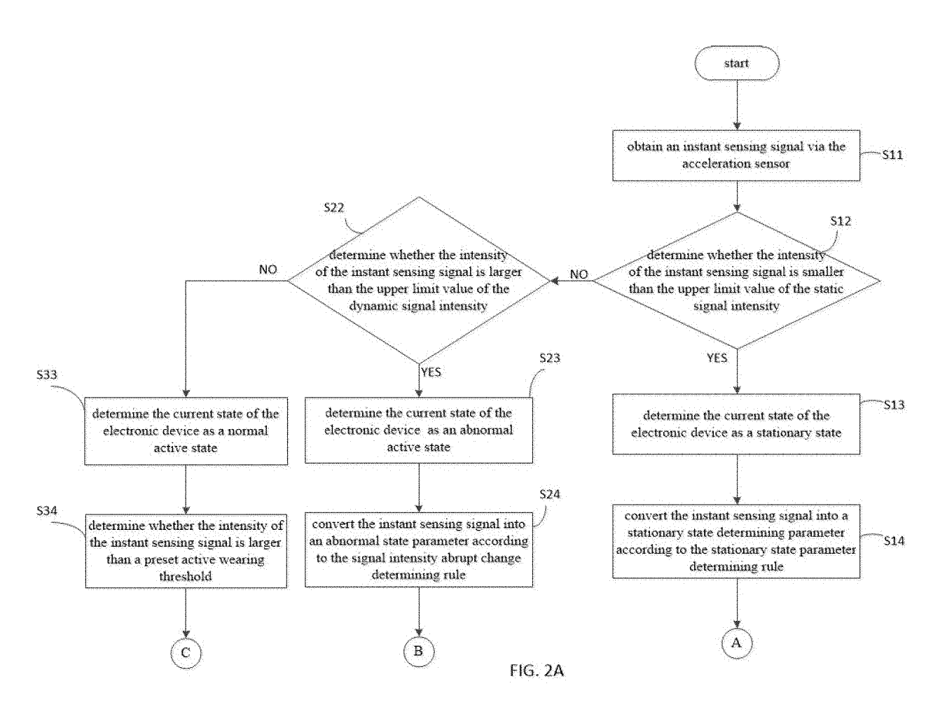

FIG. 2A and FIG. 2B are flow charts of the monitoring method in an embodiment. The monitoring method in the embodiment includes the following steps.

In step S11, an instant sensing signal is obtained via the acceleration sensor 1. In step S12, it is determined whether the intensity of the instant sensing signal is smaller than the upper limit value of the static signal intensity. If the intensity of the instant sensing signal is smaller than the upper limit value of the static signal intensity, step S13 is executed. In step S13, the current state of the electronic device 100 is determined as the stationary state.

In step S14, the instant sensing signal is converted into a stationary state determining parameter according to the stationary state parameter determining rule. In step S15, it is determined whether the stationary state determining parameter is larger than the preset static time domain value.

When the stationary state determining parameter is larger than the preset static time domain value, step S16 is executed. In step S16, the current state of the electronic device 100 is determined as the static wearing state. In step S17, when the stationary state determining parameter is smaller than the preset static time domain value (for example, the stationary state determining parameter is smaller than 0.028 m/s²), the current state of the electronic device 100 is determined as a static placement state.

In step S12, when it is determined that the intensity of the instant sensing signal is not smaller than the upper limit value of the static signal intensity, step S22 is executed. In step S22, it is determined whether the intensity of the instant sensing signal is larger than the upper limit value of the dynamic signal intensity.

When it is determined that the intensity of the instant sensing signal is larger than the upper limit value of the dynamic signal intensity in step S22, step S23 is executed. In step S23, the current state of the electronic device 100 is determined as the abnormal active state. Then, in step S24, the instant sensing signal is converted into an abnormal state parameter according to the signal intensity abrupt change determining rule. Then, in step S25, it is determined whether the abnormal state parameter is larger than the preset abnormal parameter.

When it is determined that the abnormal state parameter is larger than the preset abnormal parameter in step S25, step S26 is executed. In step S26, the current state of the electronic device 100 is determined as the abnormal active wearing state corresponding to the signal intensity abrupt change determining rule.

When it is determined that the intensity of the instant sensing signal is not larger than the upper limit value of the dynamic signal intensity in step S22, step S33 is executed. In step S33, the current state of the electronic device 100 is determined as the normal active state.

In step S34, it is determined whether the intensity of the instant sensing signal is larger than a preset active wearing threshold. When it is determined that the intensity of the instant sensing signal is larger than a preset active wearing threshold in step S34, step S35 is executed. In step S35, the instant sensing signal is converted into a normal active state parameter according to the signal intensity periodical change determining rule. Then, in step S36, the normal active state determining parameter is compared via the double layer probability model to determine that the current state of the electronic device 100 is one of multiple predefined normal active states.

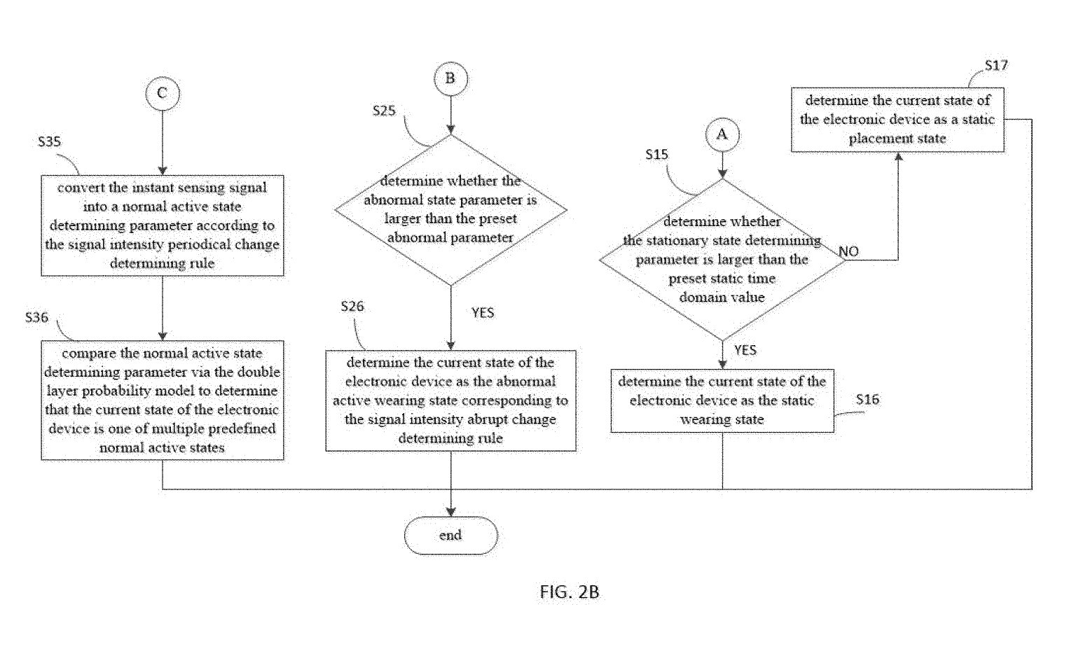

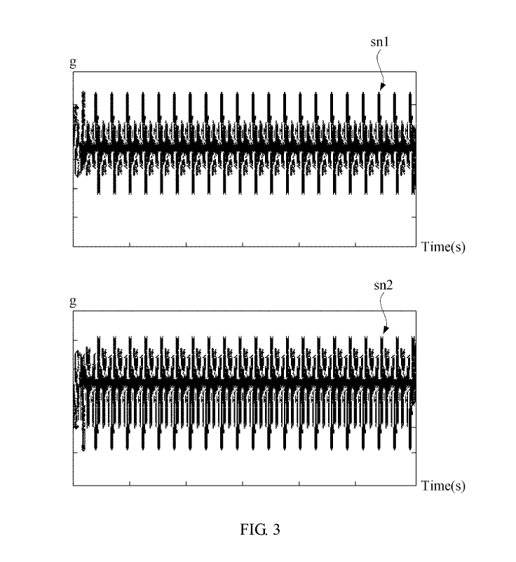

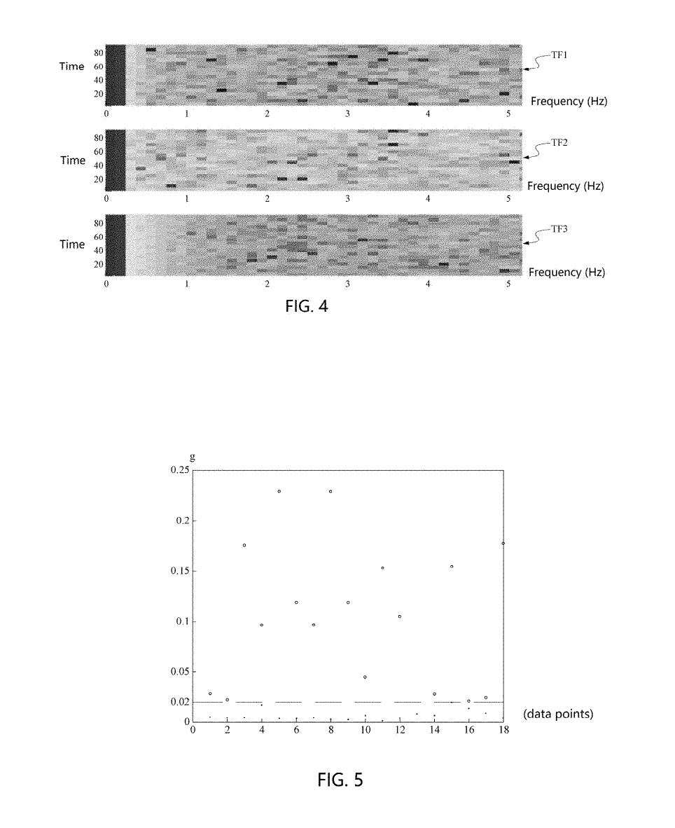

FIG. 3 is a schematic diagram showing an instant sensing signal obtained via the acceleration sensor. FIG. 4 is a schematic diagram of time frequency distribution of an instant sensing signal after a short-time Fourier transform. In the embodiment, the instant sensing signal obtained via the acceleration sensor 1 from the electronic device 100 in a stationary state is taken as an example. When the electronic device 100 is in a static placement state, an instant sensing signal sn1 is obtained via the acceleration sensor 1. When the electronic device 100 is at a static wearing state, an instant sensing signal sn2 is obtained via the acceleration sensor 1. The instant sensing signals sn1 and sn2 cannot be distinguished to correspond to the static wearing state or the static placement state before the instant sensing signals sn1 and sn2 are processed. After the instant sensing signals sn1 and sn2 are filtered, the amplitude of time domain of the instant sensing in the frequency band from 0.01 Hz to 2 Hz is remained. The distribution of the amplitude of time domain of the instant sensing in the frequency band from 0.01 Hz to 2 Hz is shown in FIG. 5.

In FIG. 4, the schematic diagram of the time frequency distribution is obtained as follows. The time domain signal is incised (for example, incising per 4 seconds). A Fourier transform is performed on a small segment of time domain signal. The spectrum intensities are represented by colors. All the spectrum intensities are arranged in stacks. The time frequency distribution diagrams TF1 and TF2 are formed by processing the instant sensing signal sensed via the acceleration sensor 1 when the electronic device 100 is disposed on a table or a computer table statically. The time frequency distribution diagram TF3 is formed by processing the instant sensing signal sensed via the acceleration sensor 1 when the electronic device 100 is wearing on a wrist and kept static. Please refer to FIG. 4, the time frequency distribution diagrams TF1, TF2 for the electronic device 100 in a static placement state are obviously different from the time frequency distribution diagram TF3 for the electronic device 100 in a static wearing state in the range of frequency band of 0.01 Hz to 2 Hz, therefore the electronic device 100 is distinguished between in a static wearing state and a static placement state easily static wearing state.

FIG. 5 is the distribution schematic diagram of the time domain amplitude signal in a specific frequency band. The time domain amplitude for the static wearing state is shown as circle symbols, and the time domain amplitude for the static placement state is shown as dot symbols. As shown in FIG. 5, in the frequency band from 0.01 Hz to 2 Hz, the time domain value of the electronic device 100 in the static wearing state is larger than 0.02 g, and the time domain value of the electronic device 100 in the static placement state is smaller than 0.02 g. As a result, in the embodiment, the frequency band corresponding to the stationary parameter determining rule and stored in the storage 31 is 0.01 Hz to 2 Hz, and the preset static time domain value corresponding to the stationary parameter determining rule and stored in the storage 31 is 0.02 g.

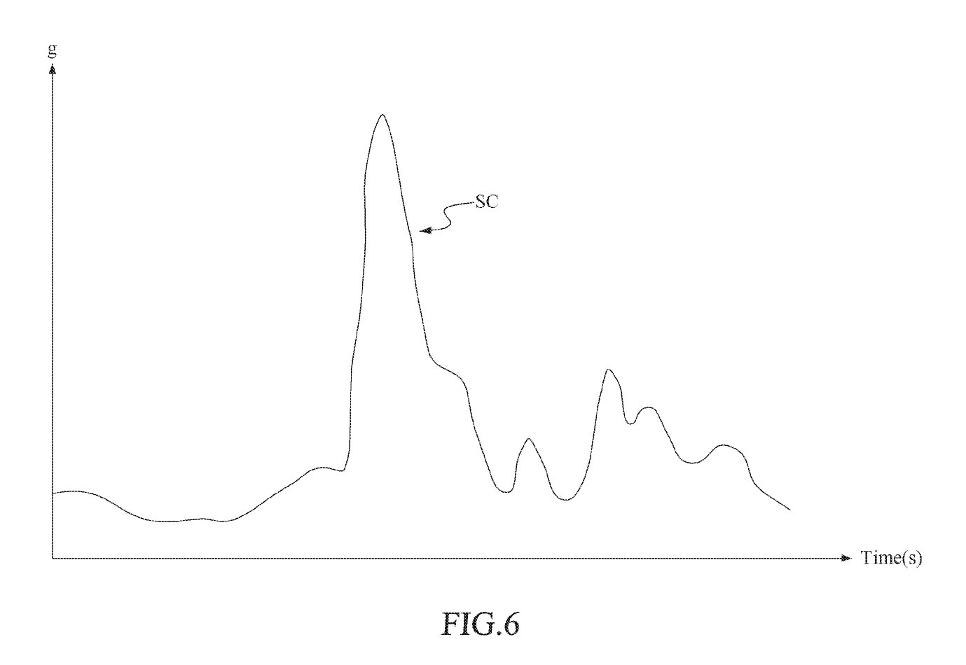

FIG. 6 is the schematic diagram of the waveform of the abnormal active state sensed via the acceleration sensor of the present disclosure. As shown in FIG. 6, in the embodiment, the waveforms of the abnormal active states are stored in the storage device 31 in the form of the acceleration characteristic features for further comparison and determination by the processor 32. In FIG. 6, the waveform in the time domain shows the change of the instant sensing signal SC sensed via the acceleration sensor 1 when the electronic device 100 falls down. When the similarity figured out by comparing the waveform change of the instant sensing signal SC in the fall down state with the preset waveform change in the fall down state (or comparing the characteristic values of the tri-axial acceleration change of the instant sensing signal SC in the fall down state with the preset characteristic values of the tri-axial acceleration change in the fall down state is larger than certain value (such as 80%), it is determined that the electronic device 100 is in the falling down state.

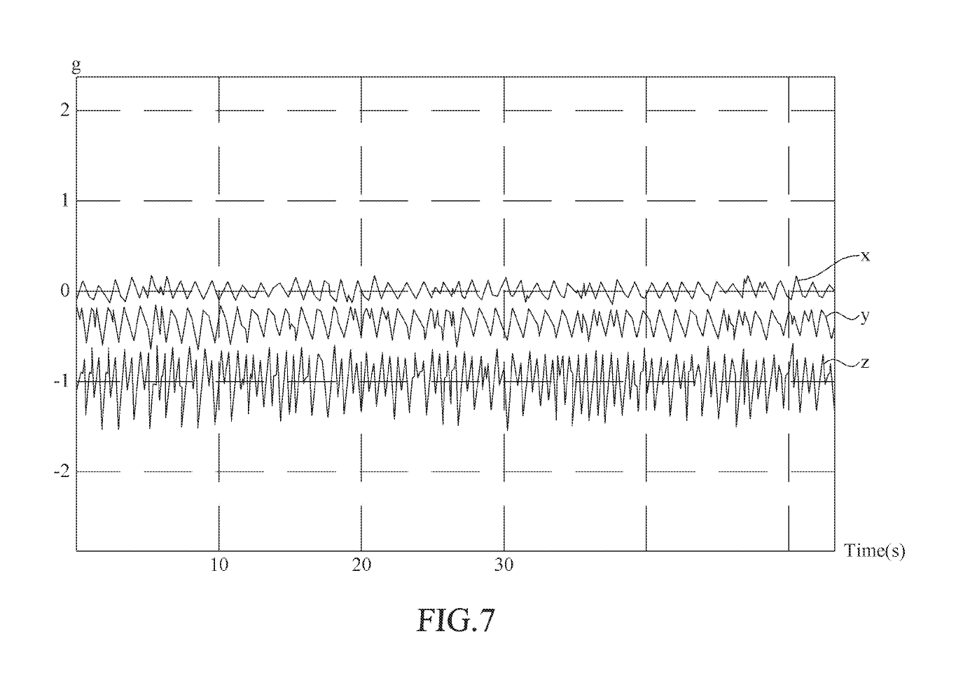

FIG. 7 is the schematic diagram of the waveform of the normal active state sensed via the acceleration sensor of the present disclosure. In the embodiment, the waveforms representing the abnormal active states are stored in the storage device 31 in the form of the characteristic features of the tri-axial acceleration change. The stored waveform is used for further comparison and determination by the processor 32. In an embodiment, the characteristic features include standard deviation, quartile deviation, and skewness. When a user wears the electronic device 10 and does exercises, the instant sensing signal sensed via the acceleration sensor 1 is processed into tri-axial time domain signals which are perpendicular to each other. The three axes time domain signals include a first axis signal x, a second axis signal y and a third axis signal z. The instant sensing signals sensed in different active states are stored in the storage device 31 for parameter determining rules.

In sum, in embodiments, the parameter determining rules and the instant sensing signals sensed via the acceleration sensor are compared to determine the current state of the electronic device. Conventionally, additional detectors are needed to be configured to detect the current state of the wearable smart electronic device. In contrast, in embodiments of the disclosure, an acceleration sensor is enough to determine the current state of the electronic device effectively without other assistant components. The production cost of the electronic device is decreased greatly. Furthermore, the power consumption of the electronic device is decreased effectively. The electronic device is a wearable smart electronic device or a smart mobile phone (which is adapted to be worn via an arm sleeve) with an acceleration sensor, which is not limited herein.

Although the invention has been disclosed with reference to certain embodiments thereof, the disclosure is not for limiting the scope. Persons having ordinary skill in the art may make various modifications and changes without departing from the scope of the invention. Therefore, the scope of the appended claims should not be limited to the description of the embodiments described above.

What is claimed is:

1. A monitoring method for an electronic device, the electronic device comprises an acceleration sensor and a storage device stored with a plurality of parameter determining rules that defining a current state of the electronic device, the monitoring method comprising:
obtaining an instant sensing signal via the acceleration sensor;
converting the instant sensing signal into at least one sensing parameter; and
determining the current state of the electronic device when the sensing parameter satisfies one of the parameter determining rules.

2. The monitoring method according to claim 1, wherein an upper limit value of static signal intensity is stored in the storage device, when the instant sensing signal is obtained via the acceleration sensor, determining whether the intensity of the instant sensing signal is smaller than the upper limit value of the static signal intensity, and when the intensity of the instant sensing signal is determined smaller than the upper limit value of the static signal intensity, the current state of the electronic device is determined as a stationary state.

3. The monitoring method according to claim 2, wherein when the current state of the electronic device is determined as the stationary state, the instant sensing signal is converted into a stationary state determining parameter of the at least one sensing parameter according to a stationary state parameter determining rule in the parameter determining rules corresponding to the stationary state.

4. The monitoring method according to claim 3, wherein when the instant sensing signal is converted into the stationary state determining parameter, and the stationary state determining parameter satisfies the stationary parameter determining rule, the electronic device is determined as a static wearing state, when the stationary determining parameter does not satisfy the stationary parameter determining rule, the electronic device is determined as a static placement state.

5. The monitoring method according to claim 4, wherein according to the stationary parameter determining rule, the electronic device is determined as the static wearing state when the stationary state determining parameter is larger than a preset static time domain value, and the electronic device is determined as the static placement state when the stationary state determining parameter is smaller than the preset static time domain value.

6. The monitoring method according to claim 2, wherein an upper limit value of dynamic signal intensity is stored in the storage device, when the intensity of the instant sensing signal is larger than the upper limit value of the static signal intensity and also larger than the upper limit value of the dynamic signal intensity, the current state of the electronic device is determined as an abnormal active state.

7. The monitoring method according to claim 6, wherein when the current state of the electronic device is determined as the abnormal active state, the instant sensing signal is converted into an abnormal active state determining parameter of the at least one sensing parameter according to a signal intensity abrupt change determining rule corresponding to the abnormal active state in the parameter determining rules.

8. The monitoring method according to claim 7, wherein after the instant sensing signal is converted into the abnormal active state determining parameter, when the abnormal active state determining parameter satisfies a preset abnormal parameter of the signal intensity abrupt change determining rule, the electronic device is determined as an abnormal active wearing state corresponding to the satisfied signal intensity abrupt change determining rule.

9. The monitoring method according to claim 6, wherein when the intensity of the instant sensing signal is smaller than the upper limit value of the dynamic signal intensity, the current state of the electronic device is determined as a normal active state.

10. The monitoring method according to claim 9, wherein when the current state of the electronic device is determined as the normal active state, the instant sensing signal is converted into a normal active state determining parameter of the at least one sensing parameter according to at least one signal intensity periodical change determining rule corresponding to the normal active state in the parameter determining rules.

11. The monitoring method according to claim 10, wherein when the instant sensing signal is converted into the normal active state determining parameter, and when the normal active state determining parameter satisfies the at least one signal intensity periodical change determining rule, the current state of the electronic device is determined as at least one normal active state corresponding to at least one signal intensity periodical change determining rule.

12. The monitoring method according to claim 11, wherein the at least one normal active state includes a walking state, a running state, a vehicle taking state or a clerical activity state.

13. An electronic device, comprising:
an acceleration sensor configured to sense and obtain an instant sensing signal;
a filter electronically connected with the acceleration sensor, wherein the filter is configured to receive the instant sensing signal and convert the instant sensing signal into at least one sensing parameter; and
a comparison and determination module electronically connected to the filter, including:
a storage device storing a plurality of parameter determining rules; and
a processor electronically connected with the storage device, wherein the processor compares the at least one sensing parameter with the parameter determining rules to determine that the electronic device is in a current state defined by one of the parameter determining rules.

14. The electronic device according to claim 13, wherein the filter comprises:
a filtering unit configured to filter the instant sensing signal to output a frequency band sensing signal according to frequency bands corresponding to the parameter determining rules;
an incision unit electronically connected with the filtering unit and configured to incise the frequency band sensing signal into at least one unit sensing signal; and
a standardizing unit electronically connected with the incision unit and configured to generate the at least one sensing parameter by standardizing the at least one unit sensing signal.

15. The electronic device according to claim 14, wherein the filter further comprises a static threshold detection unit, the static threshold detection unit is electronically connected with the filtering unit, and an upper limit value of static signal intensity is stored in the static threshold detection unit, and the static threshold detection unit receives the instant sensing signal, when the intensity of the instant sensing signal is smaller than the upper limit value of the static signal intensity, the filtering unit filters the instant sensing signal to output the frequency band sensing signal according to the frequency band corresponding to a stationary parameter determining rule of the parameter determining rules.

16. The electronic device according to claim 15, wherein the filter further comprises an abnormal threshold detection unit electronically connected with the standardizing unit, an upper limit value of the dynamic signal intensity is stored in the abnormal threshold detection unit, when the at least one sensing parameter is larger than the upper limit value of the dynamic signal intensity, the filtering unit filters the instant sensing signal to output the frequency band sensing signal according to the frequency band corresponding to a signal intensity abrupt change determining rule of the parameter determining rules; when the at least one sensing parameter is smaller than the upper limit value of the dynamic signal intensity, the filtering unit filters the instant sensing signal to output the frequency band sensing signal according to the frequency band corresponding to a dynamic parameter determining rule of the parameter determining rules.

17. A non-transient computer readable recording medium stored with at least one program instruction that applied to an electronic device, the electronic device including an acceleration sensor and a storage device stored with a plurality of parameter determining rules, after the program instruction is loaded in the electronic device, the following steps are executed:
obtaining an instant sensing signal via the acceleration sensor;
converting the instant sensing signal into at least one sensing parameter; and
determining the current state of the electronic device when the sensing parameter satisfies one of the parameter determining rules.
